(19) United States
(12) Patent Application Publication
(10) Pub. No.: US 2019/0050873 A1
(43) Pub. Date: Feb. 14, 2019

(54) POP-UP SHOP PLANNING SYSTEM

(71) Applicant: Alexandra Henderson, Dallas, TX (US)

(72) Inventor: Alexandra Henderson, Dallas, TX (US)

(21) Appl. No.: 16/102,674

(22) Filed: Aug. 13, 2018

Related U.S. Application Data
(60) Provisional application No. 62/544,700, filed on Aug. 11, 2017.

(51) Int. Cl. G06Q 30/02; G06F 17/30

(52) U.S. Cl. CPC G06Q 30/0201; G06Q 50/01; G06F 17/30867; G06Q 30/0205

(57) ABSTRACT

A mobile system by which pop-up commercial real estate and social commerce sales are generated worldwide to social media market surveys, hashtags, demographics, as well as other relevant search criteria. We are currently entering into what many would call a “retail apocalypse” which characterizes the sharp rise in brick & mortar retail business closing stores worldwide due to the booming e-commerce market. As a result, the job market has seen a plummet in retail positions; this system is not only designed to provide stability within the retail job market but is also designed to change the retail job description from just the typical sales agent to event planners and managers. This system is designed to be compatible with current social media platforms and media viewers via open source and API, in order to stimulate the marketing aspect of this system. There are five possible titles by which a user of this system can be defined as, a sponsor, retailer, event builder, pop up realtor, and the consumer. Type of account the user holds will be indicated on their social media pages via open source.

### CROSS-REFERENCE TO RELATED APPLICATION(S)

The present application claims priority to U.S. Provisional Patent Application No. 62/544,700 filed on Aug. 11, 2017, entitled “Global Social Commerce Pop up Shop” the entire disclosure of which is incorporated by reference herein.

### BACKGROUND

We are currently entering into what many would call a “retail apocalypse” which characterizes the sharp rise in brick & mortar retail stores closing worldwide due to the booming e-commerce market. As a result, attitudes on the brick & motor retail model have changed. Small vendors are setting up shop at new locations every day to attract a larger and more diverse clientele. These flexible retail locations often make an appearance as food trucks, market booths, and pop-up shops.

While flexible locations offer greater exposure, returning clients might have a difficult time relocating a pop-up shop which they enjoy. While many pop-up shops and moving vendors might post their location to social media, there lacks an effective database for clients to track, influence, and be alerted to moving vendors in their area. What is further lacking, is an effective database for moving vendors to claim a location for desired dates of retail events. What is needed is a system for better facilitating market locations for vendors and clients/customers.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a diagram which illustrates an operational overview of one embodiment.

FIG. 2 illustrates a diagram showing a mobile device such a smart phone, tablet, etc., which includes a processor, connected to memory and a display, on which the system herein may be implemented.

FIG. 3 illustrates a flowchart according to pop-up shop planning system as described herein.

FIG. 4 shows a diagram which illustrates the process by which the social media data is analyzed and then transformed into potential pop-up shop locations.

### DETAILED DESCRIPTION

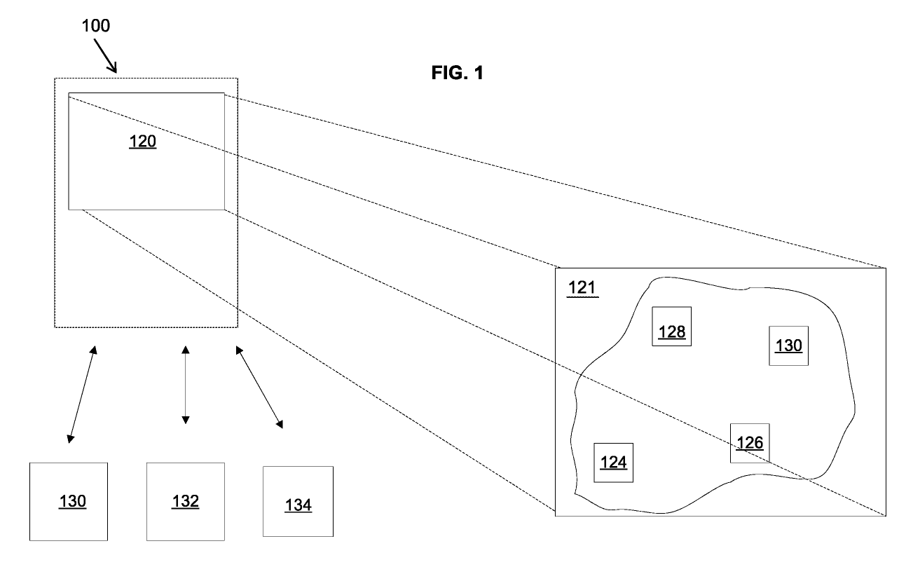

Embodiments of the present invention and their advantages may be understood by referring to FIGS. 1-4, wherein like reference numerals refer to like elements.

A pop-up real estate planning system is provided, that generates one or more maps, on a display such as the display of a mobile device, showing suitable temporary pop-up shopping locations. These temporary locations are not limited to various brick & mortar storefronts. They may be generated on a global scale, to help market and launch businesses, promotions, and goods and services that meet various social media related criteria. This system may operate compatibly with social media software as well as ecommerce and social commerce sites.

Methods of selecting from various businesses or products to launch temporary social commerce events include, but are not limited to: allowing for the public to elect brands, products, goods and services that they would like to see at a storefront location in their area; running bids that allow related businesses to purchase a temporary spot in launching locations; inviting businesses to participate according to demographics; and selection of businesses according to popular social media trends, sales, statics and etc.

In one embodiment, information is culled from one or more social media sites to which a user is logged on. Such social media sites may include Facebook™, Snapchat™ Instagram™, Twitter™, and LinkedIn™, Tumbler™, Brigade™, YouTube™, Disqus™, and Tumbler™. Data to be collected may include or originate from geographic locations of a user's followers, hashtags, metadata, geotags, cookies, search histories from social media platforms and stored data pertaining to customers, acquaintance, friends, etc. In addition, information data to be collected may originate from stories (such as temporarily display stories as with Instagram™ or Snapchat™ stories) online television, blogs, streams, etc. Unlike graphic information systems (GIS) that culls information from primarily public sources, the sources of data used herein pertains primarily to information coming from social media derived sources relating to user experiences combined with other private personal data-derived sources. The derivation of pop-up shop locations based off of user experiences combined with other private personal data-derived sources may likely yield much different results from location analysis determined from strictly public sources.

In an embodiment, data accumulated is also assigned at date to which the data was originally posted, allowing users to supplement the analysis with dates of the calendar year. This embodiment may be particularly useful when the vendor's product is seasonal, such ice cream or gluhwine. The supplemental analysis will allow a business user to better understand which dates may net greater business, in general or at specific locations.

FIG. 1 is a diagram which illustrates an operational overview of one embodiment. Mobile device 100 includes a display 120 which is has been magnified for purposes of illustration. Potential pop-up locations 124, 126, 128 and 130 appear on map 122 shown on display 120. A program executed on a processor (not shown) of a mobile device, such as a smart phone, tablet, etc. receives input generated from social media sources 130, 132, and 134. Data such as geographic locations of a user followers, hashtags, metadata geotags, cookies, search histories from social media platforms and stored data pertaining to customers, acquaintance, friends, etc. may be used to calculate metrics and serve as analytic indicators from locations of pop-up shop locations. Unlike mere demographic information, which may come strictly from available public sources of information, the social media data as used by the system disclosed herein uses data of a more privately sourced, less publicly available origin—that of a user's social media accounts. For instance, on social media sites, individuals (or “followers”) associated with a particular social media user, is often not publicly shared with other users of the social media. Consequently, certain information may only be available to followers or approved/permissioned connections to/affiliations with a user. Therefore, metrics and analytics based off of user-specific social media data are necessarily different from those taken from typical graphic information systems (GIS) which may be used to generate map data. As such social media sourced information will likely produce map data different from that derived from public information that is widely available.

Businesses (a term as used herein which includes entrepreneurs), may register through the system provided herein, as motivated by a need to expand test markets in selected areas, launch new products, generate product/services awareness and move inventory.

Businesses may be offered advertising opportunities to app users, for the system described herein, in an effort to launch products at social commerce events, including the use of market surveying methods used in social media. Examples of such methods include but are not limited to the following: allowing users to elect brands, products, goods and services that it would like to see, at a storefront location, in a locality; and providing demographics, and analytics information to the businesses according to popular social media trends, sales, statics, etc.

Pop-up shops may provide a shopping experience of an extremely limited duration. In connection with receiving the various social media data as described herein, an application running on a processor may cause the display of one or more maps highlighting one or more areas identified as presenting a high sales demand. A map may also serve as a default or fixed background to other maps. The information presented on the map may be changed according to search settings. Phrases or words input to a search engine may result in the highlighting on a map relative to where people have previously searched or purchased a product or service. In some embodiments, the application may default to highlighting locations of demand and social-following according to the information a user has initially entered into the application as background info.

A second map (not shown) is contemplated in some embodiments and it may be used as a first stage where the user will be able to engage in the forming of live auctions. Here the user will be able to view the pinpointed locations of auctions on map 122 which may be color-coded by pop-up style and which may include the mapped locations of the user's own live auctions (if any) which may appear with information pertaining to the active bidding and time left in the auctions.

In some embodiments, events may be launched through the system herein which may be themed according to social media trends. In some embodiments, such a system is intended to launch pop-up events at popular or trending locations according to demand criteria input to the system, through a mobile device, in a way that uses social commerce, e-commerce and brick & mortar marketing techniques which leverage the collection of consumer data. Predictive global marketing site maps may additionally help a business owner choose the best location to launch an event based off of market demand.

As used with the system described herein, in some embodiments there may be three different types of participant accounts: consumer accounts, service accounts and business accounts. Consumer accounts include those within a consumer's market that participating businesses are trying to reach. The qualifications of consumer participation, are simply that they have a certain social media account(s). That requirements for consumer participation may vary according to the criteria set by the owner of the system as well as those set by businesses launching a respective event.

Service account holders are registered with the system as builders or promoters of popup events.

Business account holders are those seeking to reach a consumer's market through the system's services. They are registered with business accounts that allow them to create customizable popup events through the use of registered service accounts.

Consumers receive word of a local launch or event through social media or through various social media related marketing outlets. Launching methods include but are not limited to, promotions sent to consumer social media accounts meeting certain market demand criteria relative to a respective upcoming event.

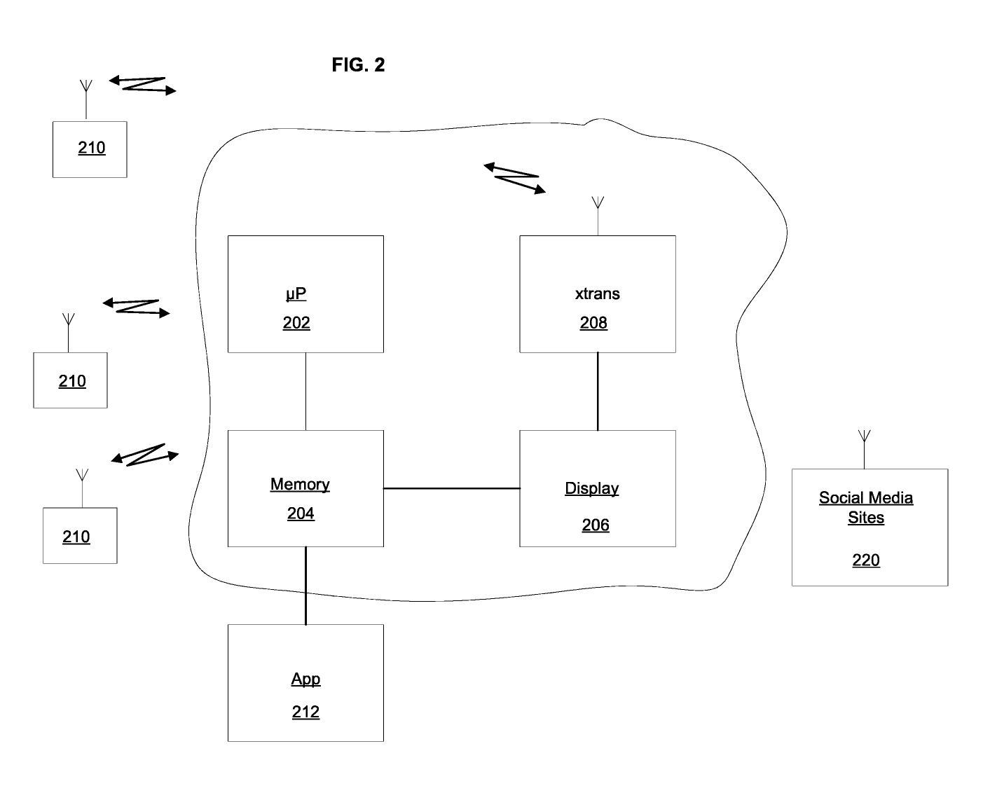

FIG. 2 illustrates a diagram showing mobile device 200 which includes processor 202 connected to memory 204. Display 206 and transceiver 208 are also connected to processor 202 (shown here as a microprocessor μP). Antenna 209 connected to transceiver 208 provides a wireless connection to various entities associated with the system such as business account holders 210. Pop-up shop planning application (app) 212 according to the foregoing is stored in memory 204 for execution by processor 202. Pop-up shop locations are shown on a map, generated by processor 202, on display 206.

Business account holders 210 use app 212 in connection with mobile device 200. Social media access by mobile device 200 to social media locations is indicated by the connection of block 220, which represents social media accounts, to antenna 209 although the connection to block 220 may also be achieved through Internet connectivity in addition to or including a wireless connection.

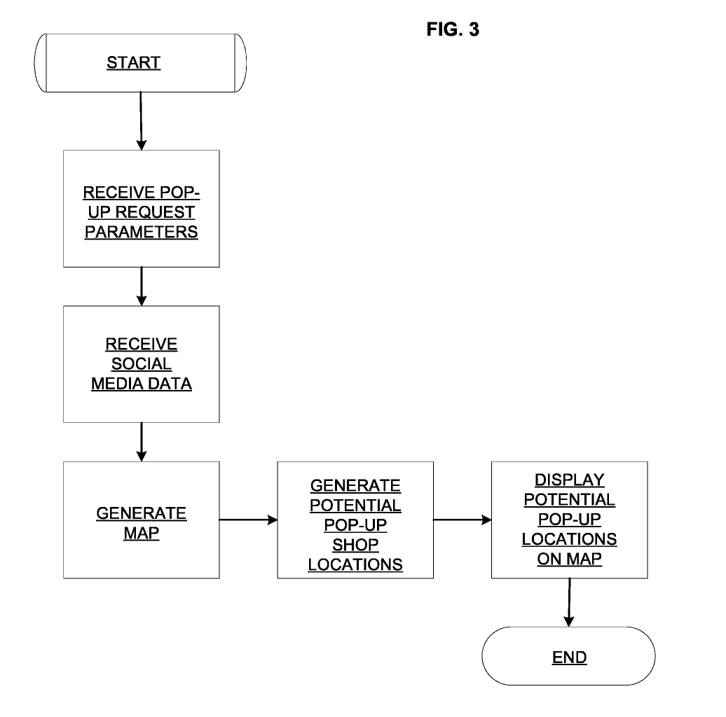

FIG. 3 illustrates a flowchart according to pop-up shop planning system as described herein. The program flow starts at step 300. Pop-up shop requirement parameters may be input to the application (app) at step 302. These parameters may include the lot size needed for a venue, the dates needed for use, special accommodations required for the pop-up event, the general geographic area in which pop-up shops may be located, etc. Social media data is received at step 304. This data may come from both public and private social media accounts as well as existing sales data and public demographic database information. A generalized map covering a potential sales area of pop-up shop locations is generated at step 306. Potential pop-up shop locations are determined at step 308. The possible pop-up shop locations are indicated on a computer display on the map at step 310. These locations may be rank ordered in terms of desirability based upon the input information entered.

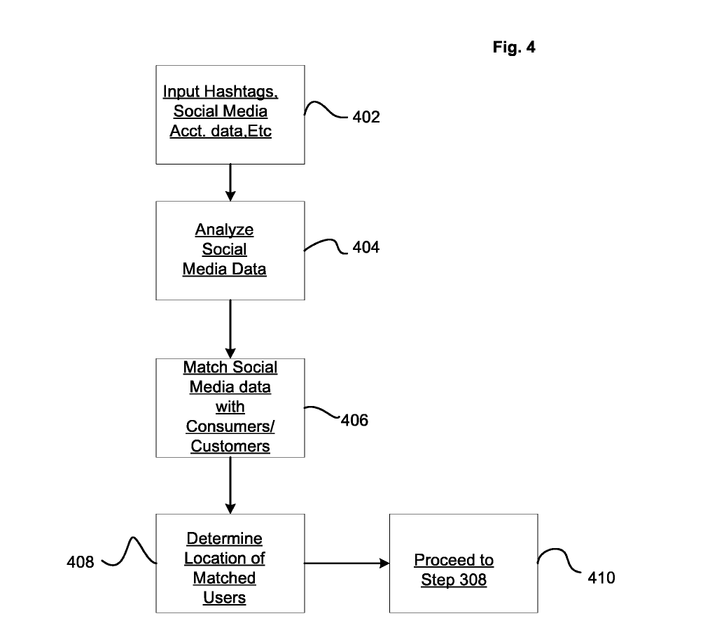

FIG. 4 shows a diagram which illustrates the process by which the social media data is analyzed and then transformed into potential pop-up shop locations. In step 402, topic characterizations, headings, etc. such as hashtags, are input to memory 204 according to app 212 (see FIG. 2). In step 404 this social media data, (such as commentary as found on blogs and tweets), metadata, photographic content and photograph headings are analyzed for certain words that were provided through app 212. In some embodiments, audio, photographic (including video) information is analyzed for certain content by processor 202. As the social media data contemplated occurs in a digital format, it is possible to analyze photographic information using image processing software. At step 406, processor 202 executes app 212 so that a match may be made between searched content and social media users connected with the searched content. Consequently, should a search term involve antique furniture, then blogs, tweets, hashtags, geotags, photographs, video (and associated headings of the photos or videos) are searched for the existence of the term “antique furniture” or some variation thereof. The social media user associated with the searched term is identified (i.e., matched) and in step 408, the location of this matched user is determined. Such a social media user location may be determined in connection with information from social media user-specified contact information listed online, public databases, and private databases (such as those already held by a user of the application as described herein). After determining the locations of matched social media users, the program according to application 212 generates the map at step 306. App 212 then generates the potential pop-up shops locations on the map at step 308, as shown in FIG. 3.

The transformation of the application user's social media data into the display, on a computing device, as potential pop-up shop locations on a map presents a significant advantage to using only publicly available data. Potentially, the system as described herein, allows for the use of better pop-up planning as the application user's social media presence and interaction grows.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, an Open Source operating system or other operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

The display as used herein is contemplated as a light emitting diode (LED) display, liquid crystal display (LCD), microelectromechanical systems (MEMS) display or any display suitable for use with a computer of mobile computing device.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

The foregoing has been described herein using specific embodiments for the purposes of illustration only. For instance, although the foregoing has been presented in connection with use on a mobile device, embodiments are contemplated with use on a stationary computer. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A computer-readable, non-transitory, programmable product, comprising code, executable by a processor, for causing the processor to do the following:
receive search criteria
receive social media data;
search the social media data for search criteria content;
identify a plurality of social media users associated with the search criteria content;
generate a map, on an electronic display, based on pop-up shop location parameters;
generate pop-up shop locations from locations associated with the plurality of social media users; and
populate the map with one or more pop-up shop locations identified as satisfying the search criteria for social media data and pop-up shop location parameters.

2. The computer readable media as recited in claim 1 further comprising code for causing the processor to receive public demographic data; the public demographic data being used in conjunction with the social media data and pop-up shop location parameters to generate the pop-up shop locations.

3. The computer-readable media as recited in claim 1 wherein pop-up shop location parameters are selected from the group consisting of lot size needed for a venue, dates needed for use, special accommodations required a pop-up event, a general geographic area in which pop-up shops may be located, and a combination thereof.

4. The computer-readable media as recited in claim 1 wherein the social media data is selected from the group consisting of hashtags, tweets, comments, metadata, audio data, visual data, blogs, content headings, content metadata and a combination thereof.

5. The computer-readable media as recited in claim 1 wherein the display is selected from the group consisting of a LED display, a LCD display or a MEMs display.

6. A method to identify pop-up shop locations, comprising:
receiving pop-up shop parameters;
generating a map according to at least some of the pop-up shop parameters;
receiving social media data;
searching social media content for one or more words according to search criterion;
identifying a plurality of users associated with the search criteria;
generating pop-up shop locations based off of the social media data in connection with identifying the locations of the plurality of users; and
displaying the pop-up shop locations on the display of a device.

7. The method as recited in claim 6 wherein the device is a mobile device selected from the group consisting of a mobile phone display, a tablet display or a computer display.

8. The method as recited in claim 6 wherein the social media data is selected from the group consisting of hashtags, tweets, comments, metadata, audio data, visual data, blogs, content headings, content metadata and a combination thereof.

9. The method as recited in claim 6 wherein pop-up shop location parameters are selected from the group consisting of lot size needed for a venue, dates needed for use, special accommodations required a pop-up event, a general geographic area in which pop-up shops may be located, and combinations thereof.

10. The method as recited in claim 6 further comprising receiving public demographic data; the public demographic data being used in conjunction with the social media data and pop-up shop location parameters to generate the pop-up shop locations.
